(19) United States
(12) Patent Application Publication
(10) Pub. No.: US 2012/0053042 A1
(43) Pub. Date: Mar. 1, 2012

(54) DRY METHOD FOR SURFACE TREATMENT

(75) Inventors: Ronny Pieters, Jumet (BE); Florent Scarso, Jumet (BE)

(73) Assignee: AGC Glass Europe, Bruxelles (Watermael-Boitsfort) (BE)

(21) Appl. No.: 13/318,677

(22) PCT Filed: Jun. 2, 2010
(86) PCT No.: PCT/EP2010/057700

§ 371 Date: Nov. 3, 2011

(30) Foreign Application Priority Data
Jun. 3, 2009 (EP) 09161771.2

(51) Int. Cl. C03C 15/00; C03B 25/00; C03C 3/00

(52) U.S. Cl. 501/11; 65/31; 216/97; 216/55

(57) ABSTRACT

The present invention discloses a method for treating at least a portion of at least one surface of a glass article which comprises the following steps, whatever their order: dry application of at least one high-pH solid material on said portion; heating of said glass article to a temperature at least equal to the melting temperature of the said high-pH solid.

### FIELD OF THE DISCLOSURE

The present invention relates to a method for treating a solid body, in particular a glass article, in order to produce a texture on the surface, for instance a matted, opaque or frosty appearance.

### BACKGROUND OF THE DISCLOSURE

The matting of a glass by etching, especially glass panel, is normally carried out by treating the surface of the glass with hydrofluoric acid vapor or with etching liquids containing hydrofluoric acid (HF). Unfortunately, due to the high toxicity of HF, the treatment of glass surface can be a dangerous and messy operation.

Attempts to avoid the use of hydrofluoric acid have been developed. For instance, the document GB 1299531 discloses a process which utilizes a solution of an alkali in a mixture of lower alcohol and water. The article published by R. F. Bartholomew in the Journal of the Electrochemical Society, Vol. 112, N° 11, p. 1120-1123, 1965 discloses that the attack of the glass thanks to the use of molten hydroxides baths lead to the formation of a frosty layer.

Unfortunately, the solutions proposed by the state of the art present limitations. On one hand, the use of etching solution is limited by the solubility of the alkali compounds in the lower alcohol-water solutions resulting in a less intense glass attack. Moreover, the use of lower alcohols implies a serious safety issue for use on an industrial line (low flash point, explosion, fire hazard, stocking). On the other hand, the use of molten hydroxides baths requires a purification process linked to the fact that the major impurity of the starting hydroxides constituting the molten bath is water. Therefore, the salts are fused and left molten for several hours before use to drive off the water; this requires a long preparation time of the etching bath.

### OBJECTS OF THE INVENTION

It is an object of the present invention, according at least one embodiment, to provide a quick, simple and alternative method, free of fluorine-containing compounds, for treating a glass article, to produce for instance a matt, opaque or frosty appearance.

A second object of the present invention, according at least one embodiment, is to provide a method leading to the reduction of the preparation time of the etching fluorine-free agent.

A third object of the present invention, according at least one embodiment, is to reduce the energy needed to perform the chemical attack of the surface.

### SUMMARY

The present invention concerns a method for treating at least a portion of a surface of a glass article which comprises the following steps, whatever their order:
dry application of at least one high-pH solid material
heating of the said glass article to a temperature at least equal to the melting temperature of the said high-pH solid.

The general terms “treating method” are used to describe a method leading to, for instance, an etching or matting or texturing of the glass surface.

The term “high-pH solid material” is used to define a material providing an increase of the pH when it is dissolved in pure water. The inventors have surprisingly found that a dry application of at least one high-pH solid material performed in an ambient atmosphere with possible water contamination does not have any effect on the chemical treatment of the surface which gives a matt appearance. Furthermore, the inventors have also surprisingly found that the dry application process leads to the same result as a wet process and therefore be used advantageously due to the fact that no bath is required and no bath preparation and purification are needed. The invention provides also a method to reduce the preparation time of the etching fluorine-free method due to the fact that the utilization of an etching bath or solution, the preparation and the purification of said bath or said solution are avoided. The invention provides thus a quick, simple and alternative method, free of fluorine-containing compounds.

In an alternative embodiment, the method according to the invention is so that the said heating is performed after the said dry application.

In another alternative embodiment, the method according to the invention is so that the glass article has a temperature at least equal to the melting temperature of the said high-pH solid material, said temperature of the glass article directly resulting from a forming process of the glass article.

The inventors have found that the temperature of the glass article immediately after leaving the former machine is high enough to lead to the melting of the high-pH solid material and therefore be used advantageously due to the fact that no substantial additional energy is needed to perform the chemical treatment of the surface.

In a preferred embodiment, the method according to the invention is so that the glass article has a temperature at least equal to 300° C., preferably at least equal to 500° C., most preferably at least equal to 550° C.

A higher temperature of the glass article leads to a more intensive contact between the surface of the glass article and the high-pH solid material in a melted state. Moreover, when the chemical treatment is performed at higher temperatures than the ambient temperature, the reaction kinetics are drastically increased.

In a preferred embodiment, the method according to the invention comprises at least a cooling step of the glass article to room temperature after the steps of dry application and heating.

In a more preferred embodiment, the cooling step includes at least an annealing step.

The annealing temperatures are at least higher than 50° C. at the end of the annealing step. The annealing temperatures are at least lower than 650° C. at the beginning of the annealing step.

In another preferred embodiment, the method according to the present invention comprises a step of removing the reaction products from the surface, said removing step being performed after the cooling step.

The terms “reaction products” are used to define products resulting from the reaction between the glass and the high-pH solid material but also the remaining initial high-pH solid material.

In a more preferred embodiment, the present invention provides a process in which the glass article is in sheet form.

In a preferred embodiment, the present invention provides a method in which the high-pH solid material comprises at least one salt selected from alkali salts and an earth-alkali salts and mixtures thereof.

The general term “mixture thereof” is used to describe a mixture comprising at least two alkali salts or at least two earth-alkali salts or at least one alkali salt and at least one earth-alkali salt.

In a preferred embodiment, the earth-alkali salt is selected from Ca(OH)₂, Mg(OH)₂, CaCO₃, MgCO₃ and mixtures of at least two thereof.

In another preferred embodiment, the alkali salt is selected from hydroxides. In a more preferred embodiment, the alkali salt is selected from NaOH, KOH and their mixture.

In a preferred embodiment, the present invention provides a texturing method, preferably a matting method.

The present invention also concerns a glass article having at least one surface of said glass article treated by the method according to any preceding embodiment.

The method according to the invention will be now described in details.

### BRIEF DESCRIPTION OF THE DRAWINGS

FIG. 1 shows a simplified method flow diagram for the production of etched glass according to the present invention

FIG. 2 shows a schematic representation of the glass article obtained according to the present invention.

### DETAILED DESCRIPTION OF THE ILLUSTRATIVE EMBODIMENTS

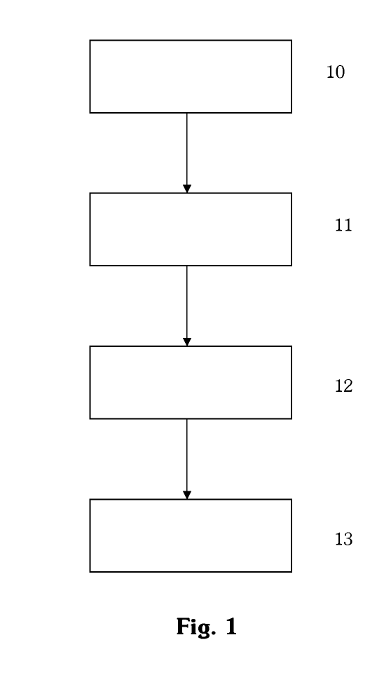

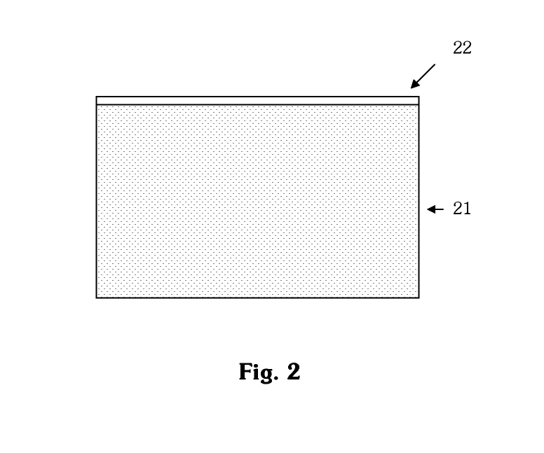

Referring now to the drawings, there are shown preferred embodiments of the method according to the present invention. FIG. 1 shows a simplified scheme of a preferred embodiment of the treating method. A glass article is heated to a temperature at least equal to the melting temperature of the high-pH solid material (10), the high-pH solid material is applied on at least a of the surface of the glass article (11), after reacting of the melted high-pH solid material with the glass surface, the glass or the glass surface is cooled down in a controlled way to room temperature with the formation of a crust of solid high-pH material (12), and finally the crust formed is removed from the glass surface (13). FIG. 2 shows a scheme of a glass article obtained after the treating method comprising a glass bulk (21) and a treated surface (22).

According to the invention, the glass surface is treated by applying a high-pH solid material such as alkali salts (NaOH, KOH, LiOH, K₂CO₃, Na₂CO₃ . . . ) or earth-alkali salts (Ca(OH)₂, Mg(OH)₂, CaCO₃, MgCO₃, . . . ) or a combination of those salts (11) and let them react with the glass surface at temperatures at least equal to, preferably higher than, the melting temperature of the high-pH solid material (10) and this without using any fluorine-containing compounds. The high-pH solid material may also comprise CaO. The high-pH solid material can be use as for instance pellets, powders, paste, . . . .

The high-pH solid material can be applied on a glass surface (11):
with the glass surface at room temperatures followed by a temperature increase of the glass or the glass surface to temperatures above the melting temperature of the high-pH solid material.
directly at glass surface temperatures above the melting temperature of the high-pH solid material (10) (e.g. ˜318° C. for NaOH, ˜380° C. for KOH). The advantage of this second approach is that the high-pH solid material can be applied during the production of, for instance, glass on a float line at high temperature and therefore no substantial additional energy is needed to execute the texturing of the glass surface.

After reacting of the melted high-pH solid material with the glass surface, the glass or the glass surface is cooled down (12) in a controlled way to room temperature with the formation of a crust of reaction products that is solidified below the melting temperature. Afterwards, the crust is removed from the glass sample, for example by washing it/dissolving it in water (13).

The invention further concerns a glass article with at least one portion of at least one surface of said glass article has been treated by the method according to the invention.

The invention also concerns the use of a glass article treated by the method of the invention for decorative applications. For example, it may be used in furniture, wardrobes, as doors for furniture, as partitions, in tables, shelves, in bathrooms, in shops displays or as wall covering.

Moreover, by a fine-tuning, a new range of possible textured surface is obtained by playing on reaction time, reaction temperature, concentration, additives (e.g. salts, . . . ), amount of applied quantity of high-pH solid materials per m², combinations more than one high-pH solid material, . . . so that other properties of the glass surface, e.g. anti-reflective, anti-fog, anti-fingerprinting, anti-fouling, easy-to-clean, anti-glare, are obtained.

The invention also concerns the use of a glass article treated by the method of the invention for solar applications, in particular when antireflective properties are obtained on the treated glass surface. For example, it may be used in solar cells or photovoltaic devices.

The following examples illustrate the invention:

### Example 1

NaOH powder (obtained by powdering NaOH pellets) was applied on a 2 mm thickness float glass sample at room temperature and the sample was put into a preheated oven during 5 minutes with the oven at a temperature of ˜400-440° C. (opening the oven renders the temperature control less precise). After 5 minutes, the hot glass sample with the molten NaOH on top was taken out of the oven and was left at room temperature to slowly cool down to room temperature with the crystallization of the crust of the reaction products. Afterwards, the crust was removed from the glass sample by water. The resulting float glass sample showed a distinct textured surface with a hazy aspect and with the following roughness parameters: Rz=8.3 μm, RSm=266.5 μm, Ra=1.6 μm (Ra is the roughness average of peak and valley distances measured along the centerline of one cutoff. RSm is the arithmetic mean value of the width of the roughness profile elements within the sampling length. Rz is the roughness average of the five highest peaks and the five lowest valleys measured in one cutoff length).

### Example 2

NaOH powder (obtained by powdering NaOH pellets) is applied on a 2 mm thickness float glass sample at room temperature and the sample was put into a preheated oven during 15 minutes with the oven at a temperature of ˜400-440° C. (opening the oven renders the temperature control less precise). After 15 minutes, the hot glass sample with the molten NaOH on top was taken out of the oven and was left at room temperature to slowly cool down to room temperature with the crystallization of the crust of the reaction products. Afterwards, the crust was removed from the glass sample by water. The resulting float glass sample showed a distinct textured surface with a hazy aspect and with the following roughness parameters: Rz=9.8 μm, RSm=539.3 μm, Ra=2.2 μm. Comparing this with the previous sample clearly shows that the reaction time plays an important role and can be used to fine-tune the desired textured surface.

### Example 3

NaOH pellets are applied on a 2 mm thickness float glass sample at room temperature and the sample was put into a preheated oven during 15 minutes with the oven at a temperature of ˜455° C. (opening the oven renders the temperature control less precise). After 15 minutes, the hot glass sample with the molten NaOH on top was taken out of the oven and was left at room temperature to slowly cool down to room temperature with the crystallization of the crust of the reaction products. Afterwards, the crust was removed from the glass sample by water. The resulting float glass sample showed a distinct textured surface with a hazy aspect.

### Example 4

KOH pellets are applied on a 2 mm thickness float glass sample at room temperature and the sample was put into a preheated oven during 5 minutes with the oven at a temperature of ˜470° C. (opening the oven renders the temperature control less precise). After 5 minutes, the hot glass sample with the molten KOH on top was taken out of the oven and was left at room temperature to slowly cool down to room temperature with the crystallization of the crust of the reaction products. Afterwards, the crust was removed from the glass sample by water. The resulting float glass sample showed a textured surface but the textured surface was not so homogeneous; the following roughness parameters were measured: Rz=7.4 μm, RSm=142.7 μm, Ra=1.3 μm.

### Example 5

NaOH pellets are deposited on the continuous glass ribbon of a float glass line at a position just after the exit of the dross box where the glass has a temperature of ˜610° C. (between 550 and 650° C.).

The conditions are the following:
Glass thickness: 5 mm
Line speed in the annealing Lehr: 8.18 m/min
Length annealing Lehr: 117 m
Pellets deposited (thrown) on the hot glass ribbon just after the exit of the drossbox on the right side of the ribbon.

The resulting float glass samples showed, after removing the crust of the reaction products, a distinct textured surface with a hazy aspect at the position where the NaOH pellets were thrown. Depending on the position of the pellets across the width of the ribon, the following roughness parameters were measured (3 different pellets):

Rz=29 μm, RSm=325 μm, Ra=5.7 μm

Rz=29.8 μm, RSm=332 μm, Ra=6.1 μm

Rz=12 μm, RSm=221 μm, Ra=1.9 μm

The present invention is not limited to the examples mentioned above. In particular the skilled person can make adjustments of parameters as for example the temperature at the end of the annealing lehr and the length of the annealing lehr. For example, the temperature at the end of the annealing lehr is in the range if 50 to 150° C. and the length of the annealing lehr may vary from 110 to 180 m.

1. A method for treating at least a portion of a surface of a glass article, the method comprising, in any order:
dry application of at least one high-pH solid material on said portion; and
heating the glass article to a temperature at least equal to a melting temperature of the said high-pH solid material.

2. The method of claim 1, wherein the heating occurs after the dry application.

3. The method of claim 1, wherein the heating of the glass article to a temperature at least equal to the melting temperature of the said high-pH solid material results from a process of forming the glass article.

4. The method of claim 1, wherein the glass article is heated to a temperature at least equal to 400° C.

5. The method of claim 1, further comprising:
cooling the glass article to room temperature after the steps of dry application and heating.

6. The method of claim 5, wherein the cooling includes at least one annealing process.

7. The method of claim 5, further comprising:
removing at least one reaction product from the surface, wherein the removing occurs after the cooling.

8. The method of claim 7, wherein the glass article is in sheet form.

9. The method of claim 1, wherein the high-pH solid material comprises at least one salt selected from the group consisting of an alkali salt and an earth-alkali salt.

10. The method of claim 9, wherein the high-pH solid material comprises the earth-alkali salt and the earth-alkali salt is at least one selected from the group consisting of Ca(OH)₂, Mg(OH)₂, CaCO₃, and MgCO₃.

11. The method of claim 9, wherein the high-pH solid material comprises the alkali salt and the alkali salt is at least one hydroxide.

12. The method of claim 11, wherein the alkali salt is at least one selected from the group consisting of NaOH and KOH.

13. A glass article, wherein at least one portion of at least one surface of the glass article has been treated by the method of claim 1.

14. A method for decorating an article, the method comprising treating at least a portion of a surface of a glass article with the method of claim 1.

15. A method for treating the surface of a solar device, the method comprising treating at least a portion of the surface of the solar device with the method of claim 1.

16. The method of claim 1, wherein the glass article is heated to a temperature at least equal to 500° C.

17. The method of claim 6, further comprising:
removing at least one reaction product from the surface, wherein the removing occurs after the cooling.

18. A glass article, wherein at least one portion of at least one surface of the glass article has been treated by the method of claim 5.

19. A glass article, wherein at least one portion of at least one surface of the glass article has been treated by the method of claim 7.

20. A glass article, wherein at least one portion of at least one surface of the glass article has been treated by the method of claim 17.
